(19) United States
(12) Patent Application Publication
(10) Pub. No.: US 2024/0233363 A9
(43) Pub. Date: Jul. 11, 2024

(54) HIGH ACCURACY PEOPLE IDENTIFICATION OVER TIME BY LEVERAGING RE-IDENTIFICATION

(71) Applicant: Meta Platforms Technologies, LLC, Menlo Park, CA (US)

(72) Inventors: Mahdi Salmani Rahimi, San Francisco, CA (US); Rahul Nallamothu, Redwood City, CA (US); Samuel Franklin Pepose, Palo Alto, CA (US)

(21) Appl. No.: 17/972,329

(22) Filed: Oct. 24, 2022

(51) Int. Cl. G06V 10/98; G06V 10/26; G06V 10/74; G06V 10/774; G06V 10/776; G06V 10/96; G06V 40/10

(52) U.S. Cl. CPC G06V 10/98; G06V 10/267; G06V 10/761; G06V 10/774; G06V 10/776; G06V 10/96; G06V 40/10

(57) ABSTRACT

In one embodiment, a method, by one or more computing systems, includes determining, based on frames captured by a camera, a plurality of participants are located in an environment, locating, within a first frame, a first body region of a first participant of the plurality of participants, detecting, at a first time, appearance information of the first body region of the first participant, calculating, using one or more machine-learning models, a confidence score corresponding to a match between the appearance information of the first participant at the first time and one or more profiles of pre-registered participants, updating, using the one or more machine-learning models, the confidence score based on one or more additional appearance information detected within additional frames, determining whether the updated confidence score is above a predetermined threshold, and in response to determining the updated confidence score is above the predetermined threshold, authenticating the first participant.

### TECHNICAL FIELD

This disclosure generally relates to image processing solutions, and in particular, related to high accuracy people identification and/or re-identification.

### BACKGROUND

A social-networking system, which may include a social-networking website may enable its users (such as persons or organizations) to interact with it and with each other through it. The social-networking system may, with input from a participant, create and store in the social-networking system a user profile associated with the participant. The user profile may include information that the participant has entered. The information may be public or private, depending on the user's privacy settings, and may include, communication-channel information, and. The social-networking system may also, with input and permission from a user, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, laptop computer, or dedicated audio/video communication interface—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

An intelligent communication device may be used for audio/visual communications, such as live or video chats or pre-recorded audio/visual presentations. The intelligent communication device may be a dedicated communication device that resides in a user's home or office. The intelligent communication device may have a touch-sensitive display screen, speakers, one or more cameras, and one or more microphones. The device may access user information in accordance with privacy settings specified by the device's owner and each user that comes within the visual field of the device. For example, the device owner may specify that under no circumstances may the device access information about anyone that is stored by the social-networking system. In this scenario, the device would not communicate with remote servers with regard to any type of user information. As another example, the device owner may specify that the device may access information stored by the social-networking system to enhance the user's experience (as will be discussed below). In this scenario, the device may communicate with the social-networking system with regard to the device owner's social-networking data, but the device will continue to check for permission to access other user's social-networking data. For example, if the device owner has opted into social-networking data access, but the device owner's friend has not opted in, the device will not access the friend's social-networking data.

Particular embodiments described herein relate to systems and methods for high accuracy people identification over time by leveraging re-identification of a person captured in an image and/or in a video frame.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example intelligent communication device in an example setting.

FIG. 2 illustrates an example intelligent communication device with example components.

FIGS. 3A and 3B illustrate an example user interaction with an example intelligent communication device.

FIGS. 4A, 4B, and 4C illustrate example visualizations for visual and audio selection.

FIG. 5 illustrates an example diagram of example inputs and decisions made by an example intelligent communication device.

FIG. 6 illustrates an example block diagram for visual data associated with an example intelligent communication device.

FIG. 7 illustrates an example visualization for performing high-accuracy identification and/or re-identification by the intelligent communication device.

FIG. 8 illustrates an example visualization for reidentifying pre-registered participants by the intelligent communication device.

FIG. 9 illustrates an example visualization of a problem arising from two overlapping people.

FIGS. 10A and 10B illustrate an example visualization of another problem arising from two overlapping people.

FIG. 11 illustrates an example visualization for disambiguating overlapping people by the intelligent communication device.

FIG. 12 illustrates an example method for high-accuracy people identification.

FIG. 13 illustrates an example network environment associated with a social-networking system.

FIG. 14 illustrates an example social graph 1400.

FIG. 15 illustrates an example computer system 1500.

### DESCRIPTION OF EXAMPLE EMBODIMENTS

An intelligent communication device may be used for audio/visual communications, such as live or video chats or pre-recorded audio/visual presentations. The intelligent communication device may be a dedicated communication device that resides in a user's home or office. The intelligent communication device may have a touch-sensitive display screen, speakers, one or more cameras, and one or more microphones.

In particular embodiments, visual data captured by the intelligent communication device may undergo one or more types of visual processing. Examples of visual processing may include but are not limited to background/foreground modeling, identifying and/or reidentifying people, disambiguating overlapping people, and any other suitable type of visual processing. Background/foreground modeling may include identifying bounding boxes corresponding to a person based on real-time multi-person 2D pose estimation data and gathering background data only for the area outside the bounding boxes.

Identifying and/or reidentifying people may involve determining, based on frames captured by a camera, that one or more participants are located within a particular environment and/or scene. Using one or more computing systems of the intelligent communication device may locate, within a frame, a body region of the first participant of the plurality of participants within the environment. The intelligent communication device may detect appearance information of the first body region of the first participant. As an example and not by way of limitation, appearance information of the first participant may include a color histogram of the person corresponding to a human skeleton, set of ratios associated with the human skeleton (e.g., hip-to-shoulder ratio), and a current location and trajectory. One or more machine-learning models may calculate a confidence score corresponding to a match between the appearance information of the first participant to one or more stored profiles of pre-registered participants.

In particular embodiments, the intelligent communication device may update, using the one or more machine-learning models, the confidence score based on additional appearance information of the participant detected within additional frames of the environment. The intelligent communication device may determine whether the updated confidence score is above a predetermined threshold, and in response to determining the updated confidence score is above the predetermined threshold, the participant may be authenticated. As an example and not by way of limitation, the intelligent communication device may determine the updated confidence score is not above a predetermined threshold, in which case the intelligent communication device may be instructed to capture additional frames over a particular time period. By running the identification process multiple times, the one or more machine-learning models may build a probability of identifying the participant with high accuracy.

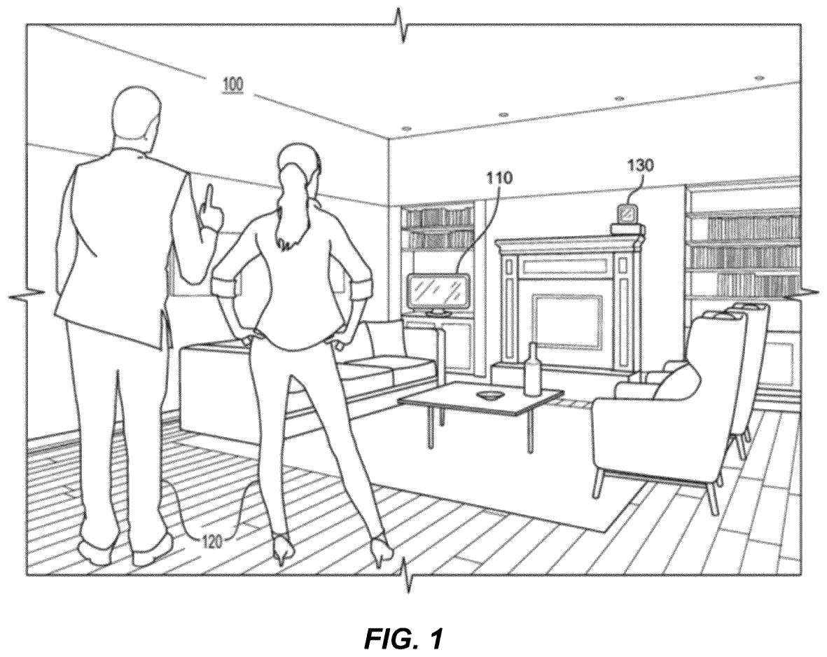

FIG. 1 illustrates an example intelligent communication device in an example setting 100. As used herein, “intelligent communication system 130” may also be referred to as “client system 130” and/or intelligent communication device 130. It is understood that these terms may be used interchangeably throughout this disclosure. Although FIG. 1 illustrates the example environment as a particular setting where the intelligent communication system 130 may be located, it is understood that the intelligent communication system 130 may be located in any suitable setting (e.g., indoors, outdoors, kitchen, backyard, park, or any other environment). The environment 100 may include the intelligent communication device 130 and many other types of objects, including people 120, and furniture, including television 110. The objects may either make up the background or the foreground of the environment. Background objects may be those objects that remain substantially unchanged throughout the duration of an AV communication session. Background objects typically include walls, furniture, appliances, doors, doorways, ceiling fans, chandeliers, etc. Foreground objects move around and/or emit sounds. Foreground objects generally include people and pets. In particular embodiments, foreground objects may also include inanimate objects, such as a television or radio, or toys (e.g., an RC racecar). In order to make appropriate cinematic decisions, the intelligent director may need to differentiate between background objects and foreground objects. That way, the intelligent director can appropriately identify people and other objects that move in the foreground.

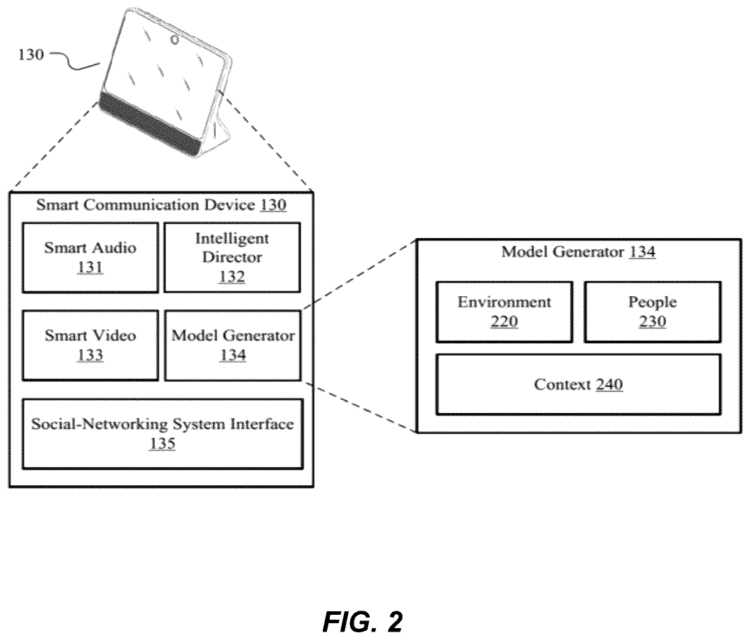

FIG. 2 illustrates an example intelligent communication device 130 with example components. Example components include a smart audio component 131, an intelligent director 132, a smart video component 133, a model generator 134, and a social-networking interface 135. Each of the components have or use the necessary processing and storage units to perform the functions discussed in this disclosure. The following discussion of model generator 134 and its associated modules and their functionality are subject to privacy settings of (1) the owner of the intelligent communication device 130, and (2) each user who is within the visual or audio space of the intelligent communication device 130. For example, the device owner may specify that under no circumstances may the device access information about anyone that is stored by the social-networking system. In this scenario, the device would not communicate with remote servers with regard to any type of user information. As another example, the device owner may specify that the device may access information stored by the social-networking system to enhance the user's experience (as will be discussed below). In this scenario, the device may communicate with the social-networking system with regard to the device owner's social-networking data, but the device will continue to check for permission to access other user's social-networking data. For example, if the device owner has opted into social-networking data access, but the device owner's friend has not opted in, the device will not access the friend's social-networking data. At a minimum, the device may identify a user for the limited purpose of determining whether the user allows access to his or her social-networking information or other identifying information. If the user does not allow such access, the device will not identify the user for any other purpose. Such privacy settings may be configured by the user on a settings interface associated with an account of the user on the online social network, as is discussed herein.

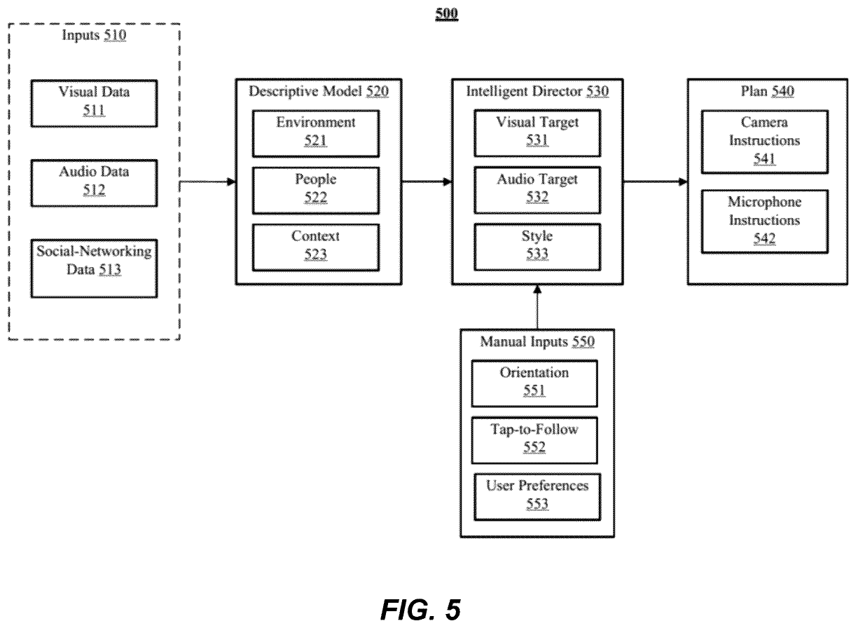

Model generator 134 may include three modules: an environment module 220, a people module 230, and a context module 240. Environment module 220 may generate information about the environment in which the intelligent communication device 130 is located in. As an example and not by way of limitation, environment module 220 may determine that its environment is indoors, and, subject to privacy settings of the device owner and any relevant user, may also determine various characteristics of the environment, such as the locations of walls, walkways, and furniture. This information may be gathered to enhance the viewing experience of viewing participants by enabling the intelligent director 132 to make more intelligent cinematic decisions. For example, if the device owner has opted in to allowing the device 130 to determine a room's layout, the environment module 220 contains information that a wall exists at a particular location, the intelligent director may instruct the camera to pan no further than the wall, because no user would walk through the wall. This information remains on the device 130 and is not sent to any remote server. This information is included in the descriptive model, which is discussed in more detail with reference to FIG. 5 below. People module 230 may generate information about the people in the environment. Only if the device owner and relevant users have expressly opted into sharing their information (e.g., social-networking information, various non-identifying mannerisms), the information about the people may include, their positions, how engaged they are with a current audio-video communication session (quantified as an “engagement metric,” discussed below), a non-identifying color histogram of each person, their talking style (e.g., fast, slow), gestures a person makes, and other suitable information. People module 230 may generate information for the descriptive model, which is discussed in more detail with reference to FIG. 5 below. If the device owner and relevant users have opted into sharing their information (e.g., social-networking information, various non-identifying mannerisms), context module 240 may generate information about the context of a particular AV communication session, such as the date or time of the AV communication session, the room the AV communication session is occurring in, the number of participants in the AV communication session, the orientation of each intelligent communication device, or the relationship between AV communication session participants (e.g., spouses, coworkers, schoolmates). In particular embodiments, if the users have expressly opted in to sharing social-networking information, context module 240 may receive social-networking information about the users who are participating in the AV communication session from the social-networking system via the social-networking system interface 135.

In particular embodiments, an AV communication session may involve an intelligent communication device 130 and at least one other device, which may be another intelligent communication device 130 or any other communication device, such as a smartphone, laptop computer, tablet, or a VR device. During the AV communication session, each participating intelligent communication device may both (1) send audio and visual data to the other participating devices, and (2) receive audio and visual data from the other participating devices. Thus, each participating intelligent communication device may be both a sending device and a receiving device. As an example and not by way of limitation, an AV communication session may include four intelligent communication devices among four different users. Each of those devices may send audio and visual data to the other three devices and may receive audio and visual data from the other three devices. Although this disclosure uses the terms “sending device,” “sending user,” “receiving device,” and “receiving user,” this disclosure contemplates that each device and user is both a sender and a receiver, because in an AV communication session, all devices send and receive information.

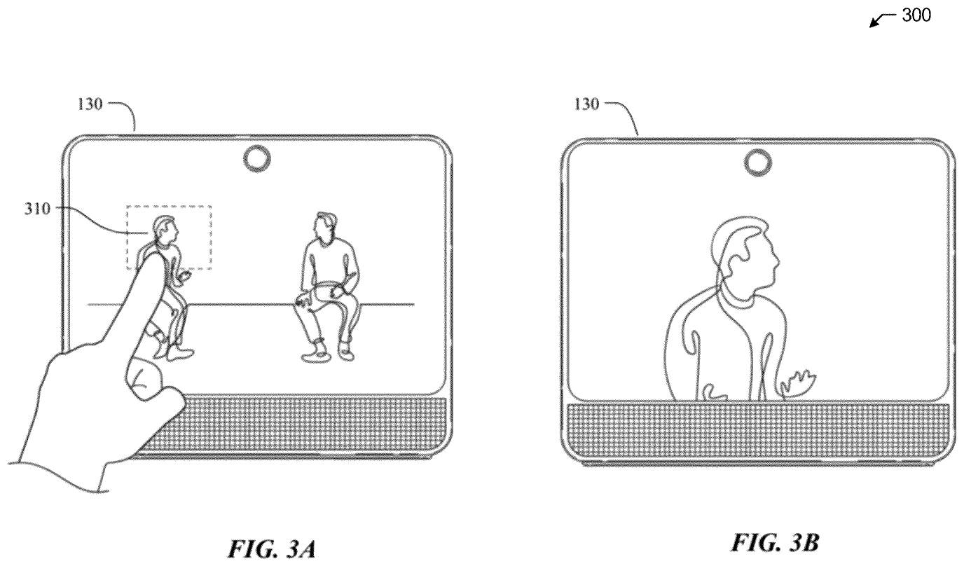

FIGS. 3A and 3B illustrate an example user interaction with an example intelligent communication device. In FIG. 3A, the intelligent communication device may display a scene with two people who are talking to each other and to a user participant association with the intelligent communication device 130. The intelligent communication device 130 may track the movement of each participant as the participant moves across the environment (e.g., moves across multiple frames).

As an example and not by way of limitation, intelligent communication device 130 may track a particular person inside box 310, wherein intelligent communication device 130 may digitally zoom in on the space inside box 310. In particular embodiments, if a first user has expressly specified that he or she allows a “following feature,” a second user may tap on the screen of the device at a location corresponding to the first user, and the second user's tap may cause the intelligent communication device to follow the second user as he moves around the environment while still maintaining a tight, zoomed-in view of the second user. The first user's tap may also cause the audio coming from the person to be amplified relative to other noises in the environment if the second user has expressly opted into allowing his or her voice to be amplified relative to other sounds.

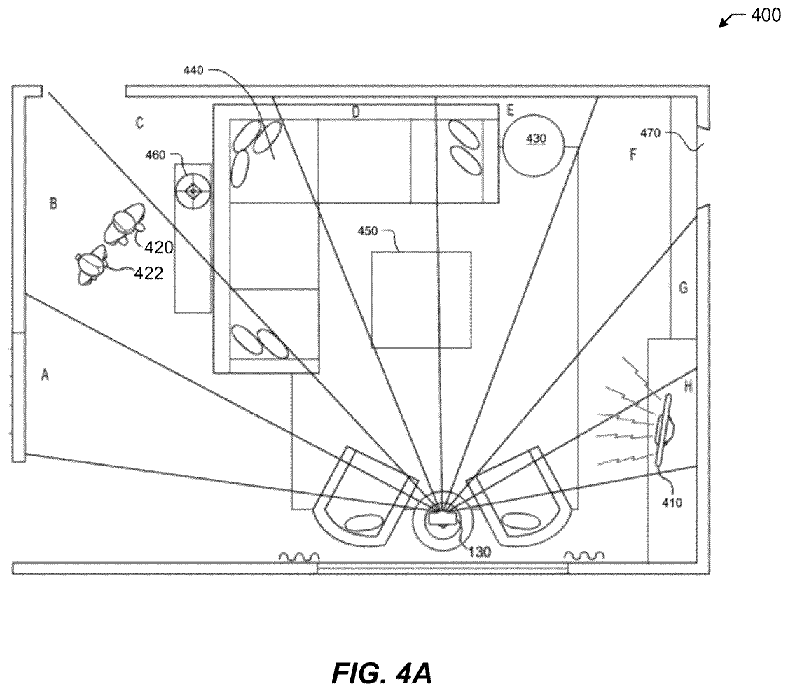

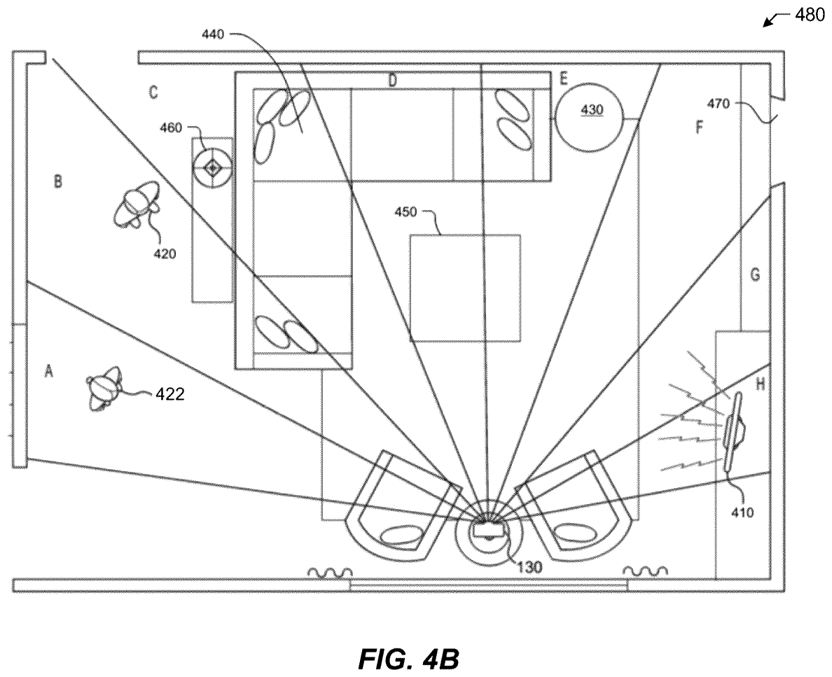

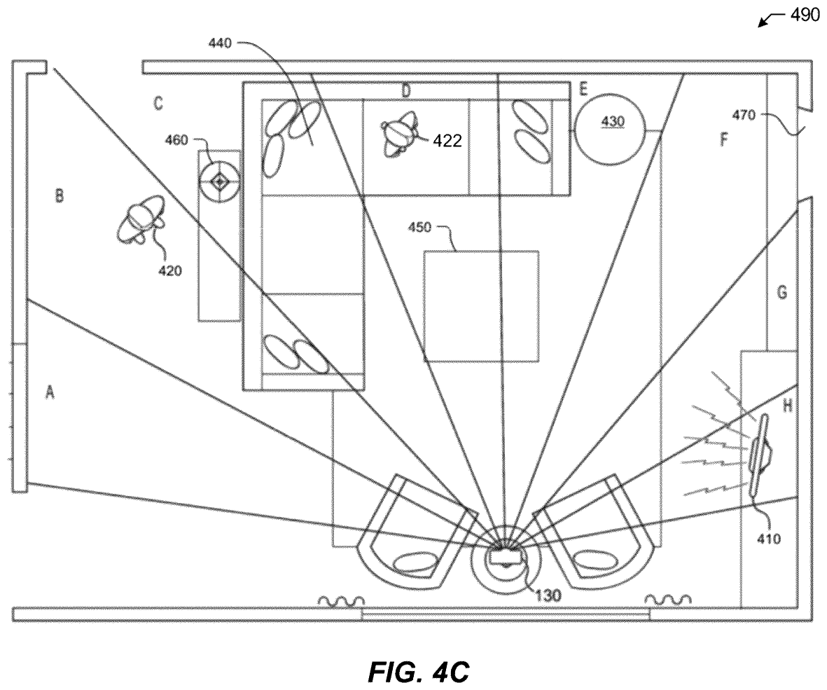

FIGS. 4A, 4B, and 4C illustrate example visualizations for visual and audio selection. FIG. 4A illustrates an example visualization 400, wherein the intelligent communication device 130 may divide its environment up into several “slices.” In the example of FIG. 4A, the scene is divided into eight slices, A through H, but this disclosure contemplates any suitable number of slices. Each of people 420, 422 and television 410 may be emitting sound simultaneously. The smart audio component 131 may identify both sound sources and determine which slice they are currently located in. Likewise, the smart video component 133 may identify both visual objects and determine which slice they are currently located in. In particular embodiments, a sound source or a visual object may occupy more than one slice. For example, a person may be straddling slices C and D. In the example of FIG. 4A, the smart audio component and smart video component may be able to determine that the sound and visual object (e.g., person) may be located in slice B.

In particular embodiments, intelligent communication device 130 may capture one or more frames of the environment (e.g., living room). In this example, intelligent communication device 130 may determine each of people 420, 422 are located within slice B. The intelligent communication device 130 may capture a first frame with identification information for each of the pre-registered participants (e.g., people 420, 422). In particular embodiments, the intelligent communication device 130 may be instructed to capture one or more frames of the environment from the moment a pre-registered participant is detected entering the environment. As an example and not by way of limitation, the intelligent communication device 130 may continuously track the pre-registered participant, such as person 422, in a plurality of frames as they move across the environment. The intelligent communication device 130 may then match all the frames captured within that time period (e.g., 30 seconds) against the pre-registered identity profiles and use accumulated confidence scores to authenticate the pre-registered participant.

As an example and not by way of limitation, the appearance information of one or more body regions of person 420 may be calculated via one or more machine-learning models to have a confidence score above a predetermined threshold, therefore authenticating person 420 against their pre-registered profile. However, the identification information corresponding to person 422 within the first frame may fail to produce a confidence score above the predetermined threshold. In this case, intelligent communication device 130 may execute instructions to capture a second frame at a second time, third frame at a third time, fourth frame at a fourth time, and so on until the identification information yields a confidence score above the predetermined threshold, and ultimately authenticating the second participant against their pre-registered profile. In this way, even if for each frame the intelligent communication device 130 only has a 50% confidence of an accurate user authentication in a first frame, over several frames, the likelihood of a false detection becomes statistically improbable (e.g., chances of a false detection ½×½×½ . . . becomes very small). As one or more machine-learning models update the confidence score in accordance with additional captured frames, the one or more machine-learning models may determine the updated confidence score is above the predetermined threshold.

In particular embodiments, once intelligent communication device 130 has authenticated people 420, 422 against their pre-registered profiles stored on one or more servers, the intelligent communication device 130 may execute one or more tasks associated with each of persons 420 and 422. As an example and not by way of limitation, the to-do list of person 420 may not be announced via an audio or visual notification of intelligent communication device 130 when person 422 is within the environment. As another example and not by way of limitation, intelligent communication device 130 may display a two-player game via one or more displays, wherein the authentication of each pre-registered participant may be utilized to track a player's turn in the game (e.g., tracking a player's turn and respective move in a game of chess).

In particular embodiments, authentication of one or more pre-registered users by intelligent communication device 130 may enable unlocking or otherwise allowing a particular user to interact with the intelligent communication device 130. By running the identification process repeatedly, across multiple frames of images captured at particular times, the intelligent communication device 130 may build a probability of the pre-registered participant being identified correctly, increasing both the speed and accuracy of recognition.

In particular embodiments, first-time users of the intelligent communication device 130 may be asked to generate an identity profile based on a plurality of appearance information (e.g., face), wherein the identify profile may be stored as a pre-registered user profile corresponding to the user by one or more servers, locally on intelligent communication device 130, or by any other suitable method.

In particular embodiments, intelligent communication device 130 may require various requirements to be satisfied (e.g., sufficient evidence of the pre-registered participants' frontal, left, and right side views) for successful identification and/or re-identification. Similarly, voice or other audio data may be required for authentication of the pre-registered participant.

FIG. 4B illustrates an example visualization 480, wherein the intelligent communication device 130 may divide its environment up into several slices. In the example of FIG. 4B, each of people 420, 422, and television 410 may be emitting sound simultaneously. The smart audio component 131 may identify all three sound sources and determine which slice they are currently located in. Similarly, the smart video component 133 may identify the visual objects and determine which slice they are currently located in. In the example of FIG. 4B, the smart audio component 131 and smart video component 133 may determine that person 422 is located in slice A, while person 420 is located in slice B.

FIG. 4C illustrates an example visualization 490, wherein the intelligent communication device 130 may divide its environment up into several slices. In the example of FIG. 4B, each of people 420, 422, and television 410 may be emitting sound simultaneously. The smart audio component 131 may identify all three sound sources and determine which slice they are currently located in. Similarly, the smart video component 133 may identify the visual objects and determine which slice they are currently located in. In the example of FIG. 4C, the smart audio component 131 and smart video component 133 may determine that person 422 is located in slice D, while person 420 is located in slice B.

FIG. 5 illustrates an example block diagram 500 of example inputs 510 and decisions made by an example intelligent communication device 130. In particular embodiments, the intelligent communication device 130 may access input data from one or more input sources. The input sources may be one or more cameras, one or more microphones, one or more metadata elements (e.g., the number of participants in either the sending or receiving environment), and one or more contextual elements associated with a current AV communication session. The camera(s) may provide visual data 511, the microphone(s) may provide audio data 512, and the contextual elements may come from social-networking data 513. In particular embodiments, the visual data 511 and the audio data 512 may be processed by one or more computing components on the intelligent communication device 130. In particular embodiments, the visual data may be 2D Pose data. 2D Pose data may include skeletons of the people in the environment. The 2D Pose data may be updated at a particular frame rate (e.g., 10 times per second). The intelligent director 132 may access the 2D Pose data at the frame rate (e.g., 10 times per second) and may instruct the camera components and audio components based on information obtained from the 2D Pose data. As an example, if the 2D Pose data indicates that a participant is moving to the left, the intelligent director 132 may instruct the camera components to pan the display to the left, to track the participant as they move across the room.

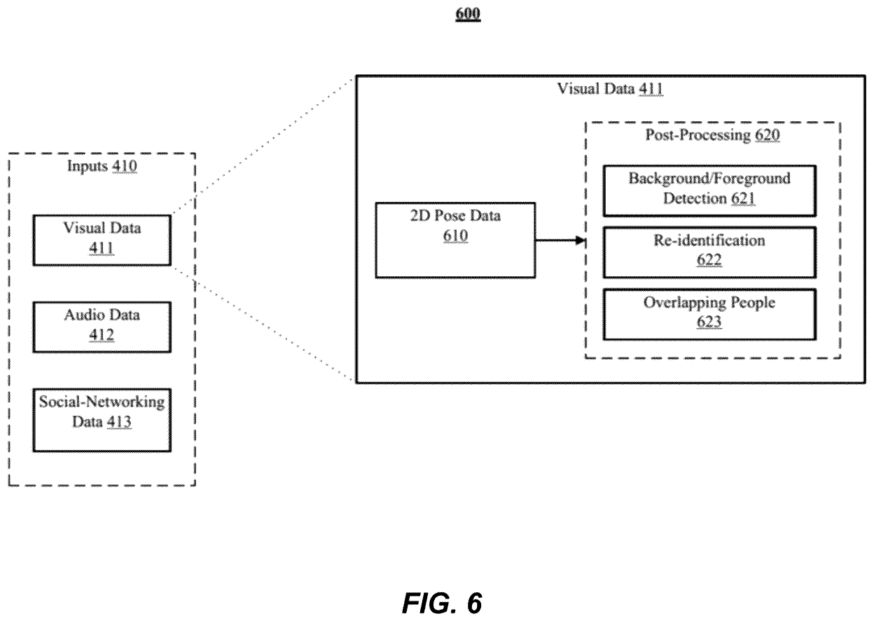

If the user has expressly opted in to 2D Pose body tracing, the 2D Pose data may provide a set of points that indicate where a person's body parts are located in the environment. If the user has expressly agreed to specific functionality in a privacy settings interface, the 2D Pose data may be detailed enough to provide points about where the user's eyes, mouth, chin, and ears are located. The intelligent director may use this data in a variety of ways. As an example and not by way of limitation, it may use the 2D Pose data to determine where a person is looking. The intelligent director may then be able to make cinematic decisions (e.g., where to direct the camera, how close to zoom the camera). For example, if three people are looking at a fourth person, the AI director may instruct the camera to zoom in on the fourth person. Processing of the visual data is discussed in more detail with reference to FIGS. 6 through 10 below.

In particular embodiments, the audio data 512 may be processed by the smart audio component 131. After being processed, the audio data 512 may include information about each sound source coming from the environment. This information may be (1) a direction that the sound is coming from relative to the intelligent communication device 130, and (2) a classification of the sound. As an example and not by way of limitation, a television set may be playing a basketball game. The smart audio component 131 may identify a sound source and classify it as the voice of a particular pre-registered participant. The smart audio component 131 may then provide this information as audio data 512 to intelligent director 132. The intelligent director 132 may use this information to make decisions about the audio. For example, intelligent director 132 may dampen television audio relative to other sounds in the environment so that a receiving participant may hear a sending participant's voice more clearly.

In particular embodiments, a computing component of the intelligent communication device 130 or a remote computing device associated with a social-networking system may generate a current descriptive model based on the input data. The current descriptive model may, subject to privacy settings of the device owner and each of the relevant users, include non-identifying descriptive characteristics (e.g., descriptive elements) about (1) the environment, (2) people within the environment, and (3) the context of the current AV communication session. The description of the environment that the intelligent communication device is currently located may be important for the intelligent director because the intelligent director may use the information to make cinematic decisions during the AV communication session.

Another metric may be the level and type of activity that is generally in the environment. For example, is the environment a room where lots of people walk through, like an entryway to a home? This type of information may be used by the intelligent director to determine how fast to pan, how close to zoom and crop individuals, or how often to cut between scenes or people. For example, if the environment is a room with high activity (e.g., a living room or entryway) the intelligent director may instruct the camera to zoom out to a larger than normal degree. For example, if the room is dark (e.g., brightness is below a pre-determined threshold level), the intelligent director may determine to brighten the room by increasing the exposure of the camera or to post-process the visual data and lighten the output video. Another metric may be the current color in the room. For example, a lamp may cast the room in an orange tint. The intelligent director may access this data and provide instructions to color-correct the room and assist in participant identification.

In particular embodiments, the current descriptive model may include non-identifying descriptive characteristics of people within the environment, as illustrated by people module 522. In particular embodiments, the descriptive characteristics may be non-identifying. The non-identifying characteristics may include a person's location, orientation, actions, engagement level, and “anchors.” In particular embodiments, if the pre-registered participant has expressly opted in to sharing personal information, the descriptive characteristics may further include the person's social-networking information. In particular embodiments, the accessed information is erased or cleared after an AV communication session has ended. In such embodiments, the device does not store information about people from one communication session to the next. Again, in such embodiments, the person's identity is not determined or recorded, even temporarily. A person's location may be where they are located in the environment. The intelligent communication device 130 may determine which people in the room have opted in to sharing their social-networking information using facial or voice recognition, or any other suitable type of recognition. The device 130 initially accesses a privacy log that has been expressly configured by the user. It may do this without accessing the user's identity because unique identifying data associated with the user's face or voice is stored in association with the privacy log so that the system can determine which log to access, but the user's name and other personal information is not stored with the privacy log. Only when the user has expressly allowed the sharing of social networking information with the device 130 may the device access the social-networking information stored in the social graph. Here, information is only pulled from the social graph—no information about any user is sent by the device to any remote server or any other remote device. If no privacy settings exist for a particular person (e.g., because they are not a user of the social-networking system), the device will not perform access on the person. If a person appears frequently and/or prominently in an AV communication session, the intelligent director may determine that she is important to the other participants in the AV communication session. She may even be the owner of the intelligent communication device. Thus, the intelligent director may instruct the camera and microphone to focus on her more than other people in the room, who may appear less frequently or less prominently.

In particular embodiments, the context of the AV communication session may be included in the current descriptive model. Context may be any information about the AV communication session, such as the date, the time, or events surrounding the date and time of the AV communication session. The intelligent communication device 130 accesses the relevant users' privacy settings and determine if any of the users has expressly opted in to sharing their social-networking data with the intelligent communication device 130. If so, the intelligent director 132 may use such information to enhance the users' experience during an AV communication session. As an example and not by way of limitation, the AV communication session may occur on a participant's birthday. A participant named Jordan may be turning 28 years old on the day of the AV communication session. The intelligent communication device 130 may access this information via the social-networking system interface component 135. The intelligent director may decide to instruct the camera to follow Jordan or to cut the scene to Jordan more often during the AV communication session, since it is likely that the other participants (e.g., grandparents, friends) may be more interested in communicating and seeing Jordan on Jordan's birthday than the other participants in Jordan's environment.

In particular embodiments, the intelligent director may use the information in the current descriptive model to identify one or more visual targets 531, one or more audio targets 532, or one or more styles 533. Visual targets 531 may be any suitable subject that the intelligent director decides is worthy of following as discussed herein. The visual target may change quickly from person to person during an AV communication session. For example, each person who talks may be a visual target while he or she is speaking. In particular embodiments, the visual target need not be tightly coupled to the audio target 533. The intelligent communication device 130 may de-couple the audio from the video. This may allow a receiving user to view one object and listen to a different sound source. As an example and not by way of limitation, the receiving user in the above example may be able to listen to the conversation happening in slice B of FIG. 4A (given that all of the users participating in the conversation have previously opted in to allowing the intelligent communication device 130 to amplify their conversations) but may be able to watch the game that is on television 410 in slice H. The user may be able to select to view this through any suitable user settings configuration, including voice commands. The intelligent communication device 130 may also be able to infer the user's desire to view one object and listen to a different sound source. This may be accomplished using any suitable means, including user preference settings. For example, an icon for video and an icon for audio may be provided. The user may select video and tap on a subject to be the video target. The user may then select audio and tap on a different subject to be the audio target. This may work well with a user who wants to view a particular subject but talk to a different subject.

Generally, the intelligent communication device 130 does not store information gathered during a given AV communication session for use in future communication sessions or for any other purpose. This may serve to protect the participants' privacy and personal information. In particular embodiments, a user or group of users may wish to have their information stored locally on the device 130 and used during future communication sessions. Storing information for future use may save computing resources and also provide an enhanced user experience. Such data is not sent to any remote device. It is only stored locally on the device 130. In particular embodiments, device 130 may generate a historical descriptive model that is based on past AV communication sessions that have occurred within the environment. The intelligent director may access the historical descriptive model when it makes its decisions.

Once the intelligent director 530 has accessed the information in the descriptive model 520, it may generate a plan 540 for the camera and microphone to follow. The plan may include camera instructions 541 and microphone instructions 542. The camera instructions may be any suitable instructions for a camera, such as instructions to zoom in on a subject, zoom out, capture multiple additional frames of the environment, or any other suitable action.

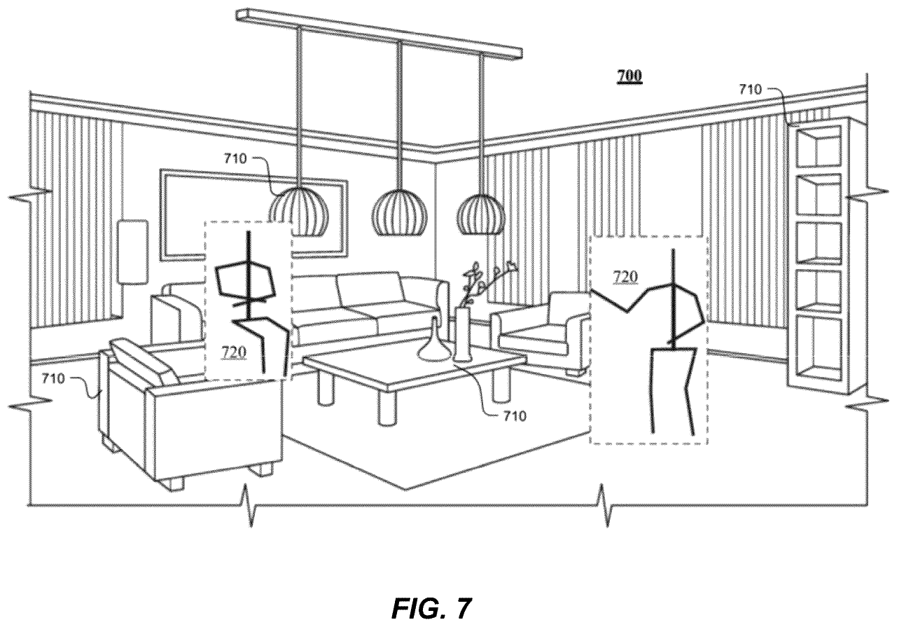

FIG. 6 illustrates an example block diagram 600 for visual data associated with an example intelligent communication device. The visual data may comprise 2D Pose Data 610 and one or more types of post-processing data 620. 2D Pose data 610 may be data that represents the two-dimensional location of a person in the environment. It may include, for each person in the environment, a set of points that correspond to a plurality of surface points of the person. For example, the set of points may indicate the major body parts of the person. For example, the 2D Pose data may include 19 x,y coordinates for each of the following body parts: top of head, chin, left ear, right ear, left eye, right eye, nose, left shoulder, right shoulder, left hip, right hip, left elbow, right elbow, left hand, right hand, left knee, right knee, left foot, and right foot. The set of points may make up what is referred to herein as a “human skeleton.” Two examples of human skeletons are illustrated within the bounding boxes 720 of FIG. 7. In particular embodiments, one or more processors on the intelligent computing device 130 (or, alternatively of a remote server associated with an online social-networking system) may process the 2D Pose data for use by the intelligent director. Three types of processing include background/foreground detection 621, re-identification 622, and overlapping people 623.

FIG. 7 illustrates an example visualization 700 for performing high-accuracy identification and/or re-identification by the intelligent communication device. The example visualization 700 may comprise a representation of an environment that an intelligent computing device may be located in. The representation of the environment may include background objects 710 as well as representations of people located in bounding boxes 720. The background objects may include furniture, walls, bookshelves, tables, chairs, carpeting, ceilings, chandeliers, and any other object that remains in the environment without moving.

The intelligent director or another component may generate a bounding box (e.g., bounding box 720) that surrounds the 2D pose data for each person. The bounding box 720 may be created for each individual in the environment. The intelligent director may be able to differentiate between animate objects (e.g., people, animals) and inanimate objects (e.g., photographs, coat racks, wall art) by measuring the movement each object makes. Generally speaking, animate objects will move much more than inanimate objects. The intelligent director may monitor each object's movement, and if an object moves more than a threshold amount, the object may be classified as animate. Or in particular embodiments, may be classified as a person, given its associated 2D Pose data is consistent with that of a person. Even if the object is only moving a little bit, this may be sufficient to classify the object as a person. For example, if someone is sleeping on the couch, his only movement may be the rise and fall of his chest as he breathers. The intelligent director may detect this and may determine that the object is a person. The intelligent director may provide instructions to gather and update background data for all points in the environment except for the areas of the bounding boxes. The old background information for bounding box regions therefore remains unchanged. This is why bounding boxes 720 in FIG. 7 show no background—this is to illustrate that no new background information is gathered about the area inside the bounding boxes—old data from previous frames may still be kept. The background 700 may be initialized with static. Static may comprise pixels that have non-uniform values e.g. for RGB images this would mean non-uniform (red, green, blue) values. This disclosure contemplates both inter-pixel and intra-pixel non-uniformity. As an example and not by way of limitation, this disclosure contemplates two adjacent pixels with RGB values of either (0, 50, 150), (0, 50, 150) or (50, 50, 50), (100, 100, 100). In other embodiments, the color space may be grayscale or HSV etc. However, for the purposes of simplicity in the drawings, bounding boxes 720 show white pixels. In particular embodiments, each pixel corresponds to a particular location within the environment. Each pixel may have an x,y coordinate value that is different from every other pixel. For example, the pixel at the bottom-left corner of the rendering of the environment may have an x, y coordinate value of (0,0). Each pixel may also have a particular RGB color value. For example, a white pixel may have an RGB color value of 255, 255, 255. A black pixel may have an RGB color value of 0, 0, 0. A green pixel may have an RGB color value of 0, 255, 0. An orange pixel may have an RGB color value of 255, 128, 0.

In particular embodiments, during an AV communication session, a participant may tap on the display screen to indicate that the participant would like to zoom in on another participant or object (e.g., a pet) in the AV communication session. In response, the intelligent director may provide instructions to crop out some of the pixels that have been tagged as background. Pixels that are tagged as background may not be very interesting to a participant, so the intelligent director may be more likely to provide instructions to crop out background pixels.

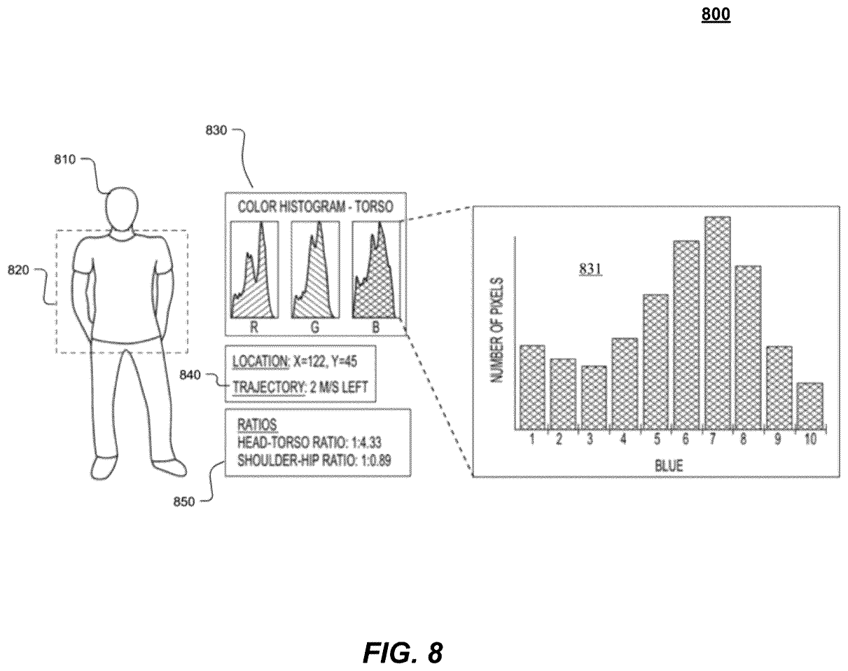

FIG. 8 illustrates an example visualization 800 for reidentifying pre-registered participants by the intelligent communication device. The visualization may include an example person 810 with example torso region 820, example color histogram 830, example location and trajectory box 840, and example ratio box 850. In particular embodiments, at a first time during an audio-communication session, processors associated with the intelligent communication device or with a remote server may determine that a first participant is located within an environment of the intelligent communication device. For example, the processor may determine that a participant 810 is within the environment. The processor may locate a first body region (e.g., torso region 820). The processor may also generate a first color histogram for the first body region. The color histogram may be a representation of the distribution of colors in an image. For digital images, a color histogram represents the number of pixels that have colors in each of a fixed list of color ranges, that span the image's color space, the set of all possible colors. For example, the color histogram may be color histogram 830. The color histogram may indicate how many red, green, blue (RGB) pixels are in the body region. The color histogram may be divided into several pixel buckets, where each column represents pixels that span part of the RGB range of color (e.g., 0-255). For example, the columns labeled 1-10 in histogram 531 may each represent the blue pixels in different ranges of colors (e.g., 0-25, 26-50, etc). The processor may determine each pixel's value and assign it to the appropriate column. This may be done separately for each RBG channel, as shown by histogram 830. Each participant may have a unique but non-identifying color histogram and the intelligent director may be able to keep track of participants by referring to their respective color histograms. In particular embodiments, the intelligent director may not identify the participant by name but may simply use the color histogram of each participant to keep track of the participants. This way, the intelligent director will not mistake one participant for another participant in the same AV communication session.

In particular embodiments, the processor may locate a second body region of the second participant that is the same as the first body region (e.g., the torso region). The processor may generate a second color histogram of the second body region, wherein the second color histogram represents a second distribution of one or more colors of the second body region. The processor may then compare the first color histogram to the second color histogram. Since no two color histograms will be exactly the same for two different people, if the processor determines that the two color histograms are the same, the processor may determine that both color histograms represent the same person. In particular embodiments, the processor may generate a new color histogram for all participants at regular intervals (e.g., 10 color histograms per second per participant).

In particular embodiments, the processor may, if any relevant user has expressly opted into this feature, also determine one or more ratios associated with the participant. Each participant may have unique body proportions relative to other users in the environment in which the device 130 is located. Thus, the processors may use these body proportions to keep track of participants in a similar manner that it uses the color histograms in a non-identifying manner. Example body proportions are provided in ratio box 840. This disclosure contemplates any suitable body ratio. Additionally, the processor may determine a current location and current trajectory of a participant. These metrics may be used to keep track of participants. For example, if a first participant is located at position x at a first time and is moving to the left, it is highly unlikely that the same participant will be located to the right of position x immediately after the first timeframe. If the processor detects a second participant to the right of position x immediately after the first timeframe, it may determine that the second participant is different from the first participant.

In particular embodiments, the processor may assign weights to each of these elements: the color histogram, the ratio metric, and the current location and trajectory metric. The elements may be weighted differently according to the dictates of a system administrator. The weights and elements may be used to calculate a re-identification score for each participant. The re-identification score may be a likelihood that the participant is a particular participant that was determined previously. For example, the system may identify a first participant and label her participant A. A short time later, the system may identify a second participant and label her participant B. The system may then compare the re-identification scores of participants A and B, and if they are within a threshold range, the processor may determine that participant B is actually participant A (i.e., they are the same person).

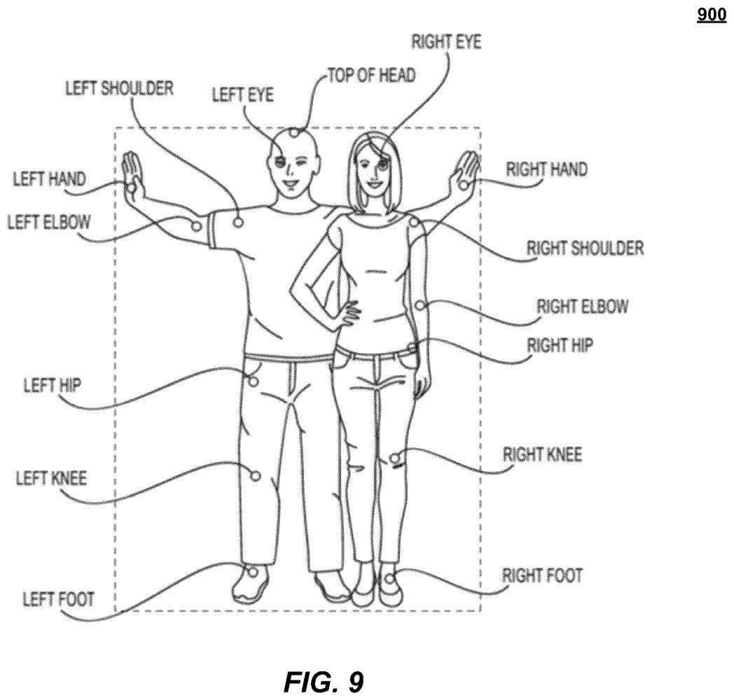

FIG. 9 illustrates an example visualization 900 of a problem arising from two overlapping people. FIG. 9 may include a bounding box that has two people in it: a man and a woman. The 2D Pose data may be unable to distinguish between two different people who are located so close to one another. Because the woman and the man are in the same space, the 2D Pose data may assign both people the same bounding box. This may be problematic because the intelligent director may think that only one person is inside the bounding box. This may lead to the intelligent director assigning labels to the wrong body parts (e.g. as shown in FIG. 9). This may cause the intelligent director to make inappropriate decisions. The solution to this problem is illustrated in FIG. 11.

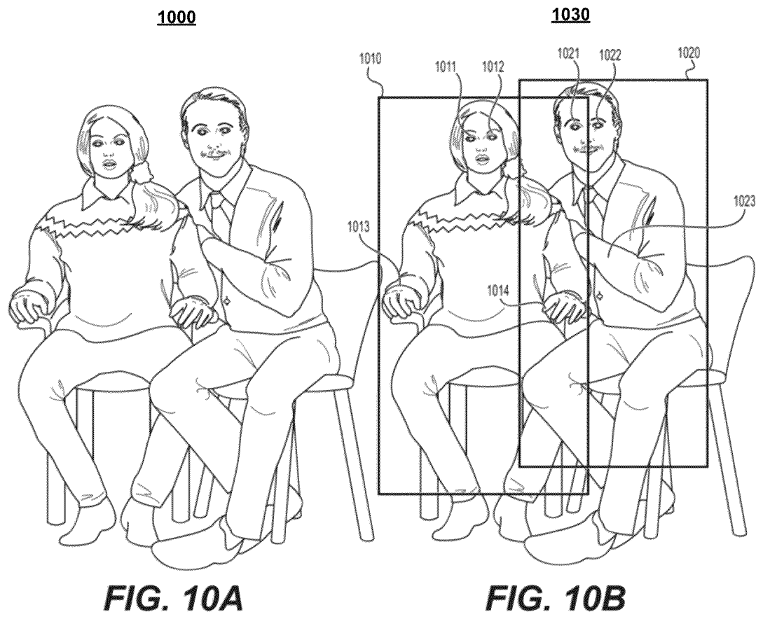

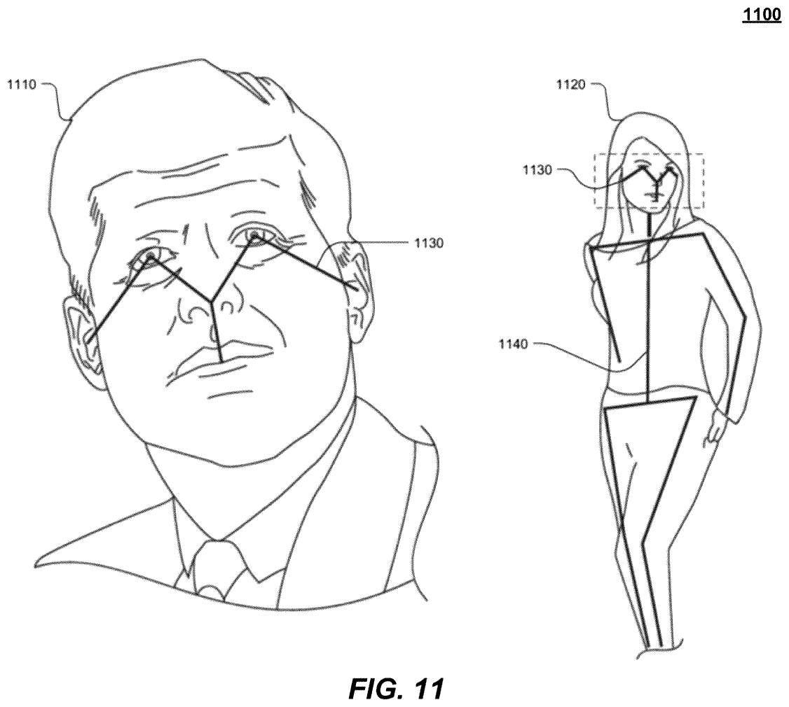

FIG. 10A illustrates an example visualization 1000 of two overlapping people.

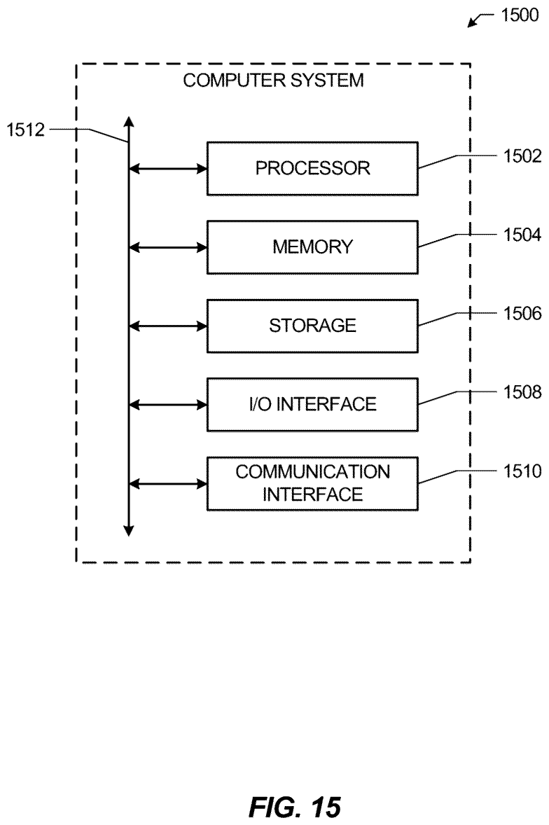

FIG. 10B illustrates an example visualization 1030 of two overlapping people and their respective bounding boxes. In the example of FIG. 10B, the two people are partially overlapping, so their respective bounding boxes are partially overlapping, as opposed to sharing the same bounding box as illustrated in FIG. 9. The woman on the left of FIGS. 10A and 10B may correspond to bounding box 1010. The man on the right may correspond to bounding box 1020. In the simplest case, each person would correspond to their own bounding box and none of the bounding boxes would overlap. Thus, each bounding box would have two eyes, two ears, two arms, two legs, etc., corresponding to the human skeleton within the bounding box. In this more complex scenario, the two people are overlapping. This may result in some irregularities that may nevertheless need to be handled by the intelligent director 132. As an example and not by way of limitation, bounding box 1020 may only contain one eye 1022, and bounding box 1010 may contain three eyes 1011, 1012, and 1021. Additionally, bounding box 1020 may contain two arms 1023 and 1014, but only one of the arms may properly correspond to the human skeleton corresponding to bounding box 1020 (e.g., the man on the right). To attribute body parts to the proper human skeleton, the intelligent director 132 may employ the process discussed with reference to FIGS. 11 and 15 below. In addition, the intelligent director may use one or more statistical models to make the proper associations. As an example and not by way of limitation, the intelligent director 132 may determine that it is statistically improbable for a human skeleton to possess three eyes. Thus, it may determine that one of eyes 1011, 1012, and 1021 may not properly correspond to the human skeleton of bounding box 1010. The intelligent director 132 may measure the distance between each of eyes 1011, 1012, and 1021. It may determine that eyes 1011 and 1012 are closer together than eye 1021 is to either eye 1011 or 1012. Statistically, it is more likely that eyes 1011 and 1012 belong to the same person and eye 1021 belongs to a different person, based on their relative distances. Thus, it may determine that eyes 1011 and 1012 belong to one person, and eye 1021 belongs to another person whose bounding box is overlapping with bounding box 1010. In particular embodiments, face detection may also serve to disambiguate overlapping people. Although this disclosure describes associating body parts to a human skeleton in a particular manner, this disclosure contemplates associating body parts to human skeletons in any particular manner.

FIG. 11 illustrates an example visualization 1100 for disambiguating overlapping people by the intelligent communication device. To disambiguate users who are overlapping and thus share the same bounding box, a processor may identify, from a set of coordinate points that correspond to a plurality of surface points of a person in an environment (e.g., 2D Pose data), a coordinate point that corresponds to a facial feature of the person. As an example and not by way of limitation, person may be person 1110 and/or person 1120. The facial feature may be the person's left eye. The processor may then generate a facial structure 1130 for a face of the person. The facial structure 1030 may attempt to map the facial features of the person's face. It may cover a plurality of facial features of the person. The facial structure 1130 may also need to substantially match a pre-determined facial structure. This is because almost all faces have features in the same relative locations: nose between and below eyes, ears outside of and slightly below eyes. If the processor can map a facial structure that matches the predetermined facial structure onto facial points in 2D Pose data, it may be more confident in determining that there is a single person associated with the facial structure. Once the facial structure has been mapped, the processor may generate a body skeletal structure 1140 for the person. The body skeletal structure may need to substantially match a predetermined body skeletal structure, because most people's bodies may have similar body structures: a torso below the head, arms and legs at the peripheries of the torso. If the generated skeletal body structure does not substantially match the predetermined structure, the intelligent director may decrease the likelihood that the generated body skeletal structure corresponds to a single person. In particular embodiments, the body skeletal structure may also align with the facial structure in at least one dimension (e.g., vertically, as shown by facial structure 1130 and body structure 1140). If this is the case, it may increase the likelihood that the generated body skeletal structure corresponds to a single person.

In particular embodiments, if the likelihood that the generated body skeletal structure corresponds to a single person exceeds a threshold, the processor may associate the generated body skeletal structure and facial structure with a particular person in the environment. The processor may not identify the person by name but may instead determine that the set of coordinate points in the 2D Pose data correspond to a single person. Based on this determination, the intelligent director may determine one or more instructions for a camera, microphone, speaker, or display screen based on the generated body skeletal structure and facial structure.

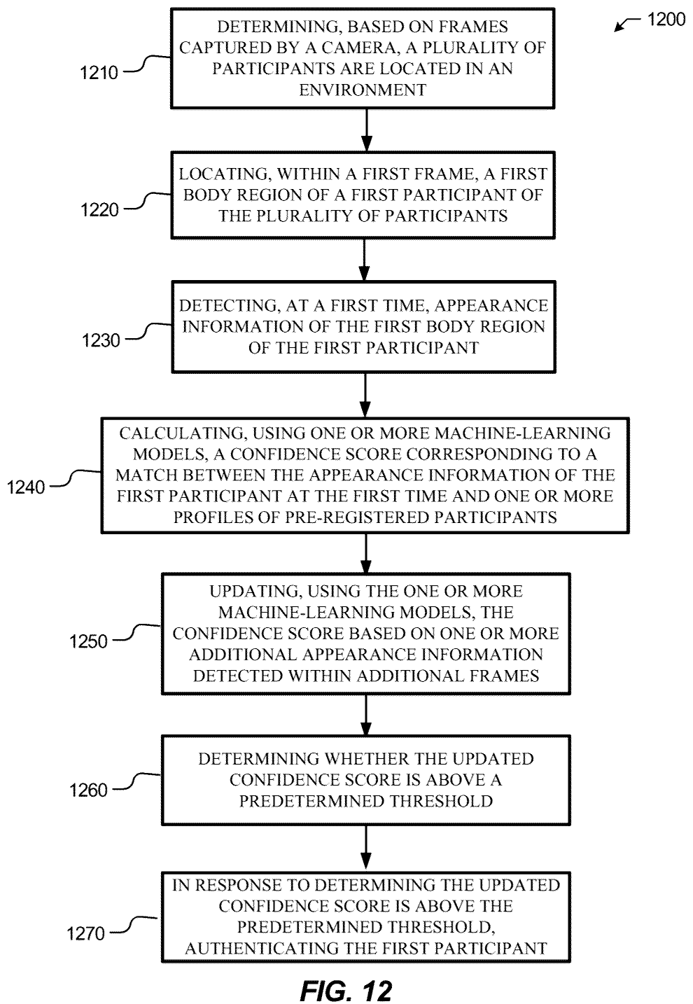

FIG. 12 illustrates an example method 1200 for high-accuracy people identification.

The method may begin at step 1210, where one or more computing systems (e.g., intelligent communication device 130) may determine, based on frames captured by a camera of intelligent communication device 130, that a plurality of participants are located in an environment.

At step 1220, the one or more computing systems may locate, within a first frame, a first body region of a first participant of the plurality of participants.

At step 1230, the one or more computing systems may detect, at a first time, appearance information of the first body region of the first participant.

At step 1240, the one or more computing systems may calculate, using one or more machine-learning models, a first confidence score corresponding to a match between the appearance information of the first participant at the first time and one or more profiles of pre-registered participants.

At step 1250, the one or more computing systems may update, using the one or more machine-learning models, the confidence score based on one or more additional appearance information detected within additional frames.

At step 1260, the one or more computing systems may determine whether the updated confidence score is above a predetermined threshold. As an example and not by way of limitation, the one or more computing systems may determine the updated confidence score is not above a predetermined threshold and instruct one or more cameras to capture additional frames of the first body region of the first participant at a second time.

In particular embodiments, at the second time, the one or more computing systems may detect the appearance information of the first body region of the first participant. The one or more computing systems may then calculate, using one or more machine-learning models, a second confidence score corresponding to a match between the appearance information of the first participant at the second time and one or more profiles of pre-registered participants. As an example and not by way of limitation, the one or more computing systems may then update the second confidence score based on the one or more additional appearance information detected within additional frames. The one or more computing systems may then determine whether the updated second confidence score is above the predetermined threshold, and in response to determining the updated second confidence score is above the predetermined threshold, the one or more computing systems may authenticate the first participant.

At step 1270, in response to determining the updated confidence score is above the predetermined threshold, the one or more computing systems may authenticate the first participant. In particular embodiments, the one or more computing systems may execute one or more tasks associated with the authentication of the first participant, wherein the one or more tasks may be based on a pre-registered profile corresponding to the first participant.

In particular embodiments, the one or more computing systems may determine one or more privacy restrictions corresponding to the one or more tasks. As an example and not by way of limitation, the privacy restrictions are determined based on the pre-registered profile corresponding to the first participant.

In particular embodiments, the one or more computing systems may locate a second body region of the first participant. As an example and not by way of limitation, the one or more computing systems may generate a color histogram of the second body region of the first participant and store the color histogram of the second body region of the first participant in a pre-registered profile corresponding to the first participant.

In particular embodiments, the one or more computing systems may locate, within the first frame, a first body region of a second participant of the plurality of participants. As an example and not by way of limitation, the one or more computing systems may detect, at a first time, appearance information of the first body region of the second participant and calculate a confidence score corresponding to a match between the appearance information of the second participant at the first time and one or more profiles of pre-registered participants. As another example and not by way of limitation, the one or more machine-learning model may update the confidence score based on one or more additional appearance information detected within additional frames and determine whether the updated confidence score is above the predetermined threshold. In particular embodiments, in response to determining the updated confidence score is above the predetermined threshold, the one or more computing systems may authenticate the second participant and execute one or more tasks associated with the first participant, wherein the one or more tasks may be based on the pre-registered profiles corresponding to the first participant and second participant, respectively.

Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for high-accuracy people identification over time by leveraging re-identification including the particular steps of the method of FIG. 12, this disclosure contemplates any suitable method for high accuracy re-identification including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

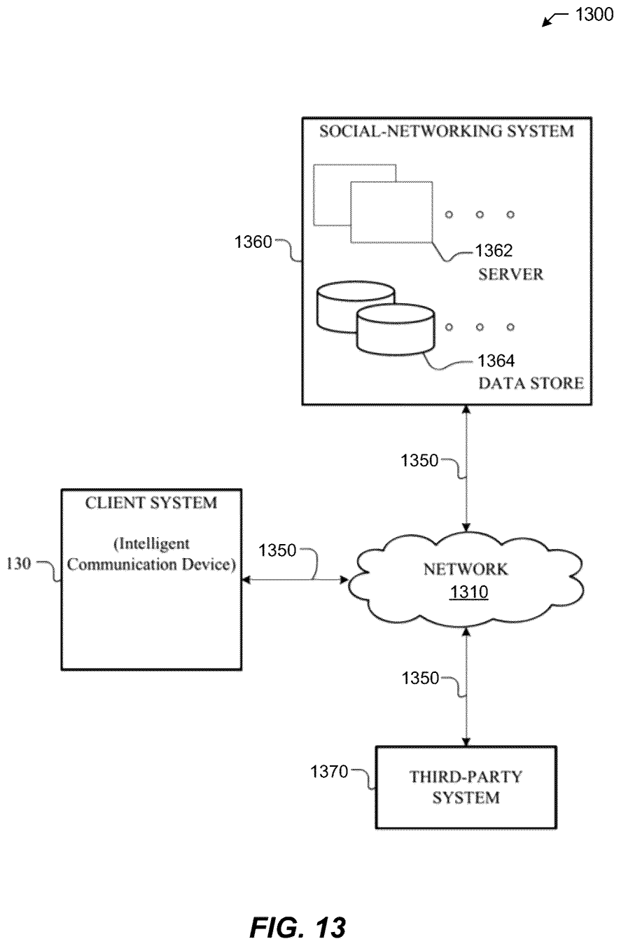

FIG. 13 illustrates an example network environment 1200 associated with a social-networking system. Network environment 1300 includes a user 1301, a client system 1330, a social-networking system 1360, and a third-party system 1370 connected to each other by a network 1310. Although FIG. 13 illustrates a particular arrangement of user 1301, client system 1330, social-networking system 1360, third-party system 1370, and network 1310, this disclosure contemplates any suitable arrangement of user 1301, client system 1330, social-networking system 1360, third-party system 1370, and network 1310. As an example and not by way of limitation, two or more of client system 1330, social-networking system 1360, and third-party system 1370 may be connected to each other directly, bypassing network 1310. As another example, two or more of client system 1330, social-networking system 1360, and third-party system 1370 may be physically or logically co-located with each other in whole or in part. Moreover, although FIG. 13 illustrates a particular number of users 1301, client systems 1330, social-networking systems 1360, third-party systems 1370, and networks 1310, this disclosure contemplates any suitable number of users 1301, client systems 1330, social-networking systems 1360, third-party systems 1370, and networks 1310. As an example and not by way of limitation, network environment 1300 may include multiple users 1301, client system 1330, social-networking systems 1360, third-party systems 1370, and networks 1310.

In particular embodiments, user 1301 may be an individual (human user), an entity (e.g., an enterprise, business, or third-party application), or a group (e.g., of individuals or entities) that interacts or communicates with or over social-networking system 1360. In particular embodiments, social-networking system 1360 may be a network-addressable computing system hosting an online social network. Social-networking system 1360 may generate, store, receive, and send social-networking data, such as, for example, user-profile data, concept-profile data, social-graph information, or other suitable data related to the online social network. Social-networking system 1360 may be accessed by the other components of network environment 1300 either directly or via network 1310. In particular embodiments, social-networking system 1360 may include an authorization server (or other suitable component(s)) that allows users 1301 to opt in to or opt out of having their actions logged by social-networking system 1360 or shared with other systems (e.g., third-party systems 1370), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. In particular embodiments, third-party system 1370 may be a network-addressable computing system that can host an online social network. Third-party system 1370 may generate, store, receive, and send social-networking data, such as, for example, pre-registered user profile data, concept-profile data, social-graph information, or other suitable data related to the online social network. Third-party system 1370 may be accessed by the other components of network environment 1300 either directly or via network 1310. In particular embodiments, one or more users 1301 may use one or more client systems 1330 to access, send data to, and receive data from social-networking system 1360 or third-party system 1370. Client system 1330 may access social-networking system 1360 or third-party system 1370 directly, via network 1310, or via a third-party system. As an example and not by way of limitation, client system 1330 may access third-party system 1370 via social-networking system 1360. Client system 1330 may be any suitable computing device, such as, for example, a personal computer, a laptop computer, a cellular telephone, a smartphone, a tablet computer, or an augmented/virtual reality device.

This disclosure contemplates any suitable network 1310. As an example and not by way of limitation, one or more portions of network 1310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1310 may include one or more networks 1310.

Links 1350 may connect client system 1330, social-networking system 1360, and third-party system 1370 to communication network 1310 or to each other. This disclosure contemplates any suitable links 1350. In particular embodiments, one or more links 1350 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1350, or a combination of two or more such links 1350. Links 1350 need not necessarily be the same throughout network environment 1300. One or more first links 1350 may differ in one or more respects from one or more second links 1350.

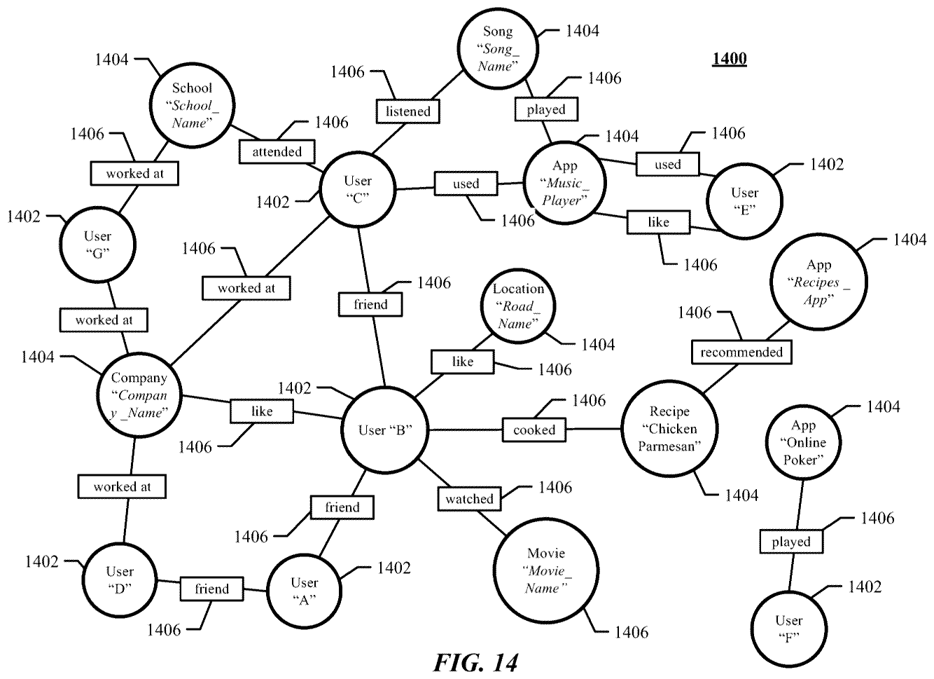

FIG. 14 illustrates an example social graph 1400. In particular embodiments, social-networking system 1360 may store one or more social graphs 1400 in one or more data stores. In particular embodiments, social graph 1400 may include multiple nodes—which may include multiple user nodes 1402 or multiple concept nodes1404— and multiple edges 1406 connecting the nodes. Example social graph 1400 illustrated in FIG. 14 is shown, for didactic purposes, in a two-dimensional visual map representation. In particular embodiments, social-networking system 1360, client system 130, or third-party system 1370 may access social graph 1400 and related social-graph information for suitable applications. The nodes and edges of social graph 1400 may be stored as data objects, for example, in a data store (such as a social-graph database). Such a data store may include one or more searchable or queryable indexes of nodes or edges of social graph 1400.

In particular embodiments, a user node 1402 may correspond to a user of social-networking system 1360. As an example and not by way of limitation, a user may be an individual (human user), an entity (e.g., an enterprise, business, or third-party application), or a group (e.g., of individuals or entities) that interacts or communicates with or over social-networking system 1360. In particular embodiments, when a user registers for an account with social-networking system 1360, social-networking system 1360 may create a user node 1402 corresponding to the user, and store the user node 1402 in one or more data stores. Users and user nodes 1402 described herein may, where appropriate, refer to registered users and user nodes 1402 associated with registered users. In addition or as an alternative, users and user nodes 1402 described herein may, where appropriate, refer to users that have not registered with social-networking system 1360. In particular embodiments, a user node 1402 may be associated with information provided by a user or information gathered by various systems, including social-networking system 1360. As an example and not by way of limitation, a user may provide his or her name, profile picture, contact information, birth date, sex, marital status, family status, employment, education background, preferences, interests, or other demographic information. In particular embodiments, a user node 1402 may be associated with one or more data objects corresponding to information associated with a user. In particular embodiments, a user node 1402 may correspond to one or more webpages.

In particular embodiments, a concept node 1404 may correspond to a concept. As an example and not by way of limitation, a concept may correspond to a place (such as, for example, a movie theater, restaurant, landmark, or city); a website (such as, for example, a website associated with social-networking system 1360 or a third-party website associated with a web-application server); an entity (such as, for example, a person, business, group, sports team, or celebrity); a resource (such as, for example, an audio file, video file, digital photo, text file, structured document, or application) which may be located within social-networking system 1360 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1404 may be associated with information of a concept provided by a user or information gathered by various systems, including social-networking system 1360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1404 may be associated with one or more data objects corresponding to information associated with concept node 1404. In particular embodiments, a concept node 1404 may correspond to one or more webpages.

In particular embodiments, a node in social graph 1400 may represent or be represented by a webpage (which may be referred to as a “profile page”). Profile pages may be hosted by or accessible to social-networking system 1360. Profile pages may also be hosted on third-party websites associated with a third-party server 1370. As an example and not by way of limitation, a profile page corresponding to a particular external webpage may be the particular external webpage and the profile page may correspond to a particular concept node 1404. Profile pages may be viewable by all or a selected subset of other users. As an example and not by way of limitation, a user node 1402 may have a corresponding user-profile page in which the corresponding user may add content, make declarations, or otherwise express himself or herself. As another example and not by way of limitation, a concept node 1404 may have a corresponding concept-profile page in which one or more users may add content, make declarations, or express themselves, particularly in relation to the concept corresponding to concept node 1404.

In particular embodiments, a concept node 1404 may represent a third-party webpage or resource hosted by third-party system 1370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing client system 130 to send to social-networking system 1360 a message indicating the user's action. In response to the message, social-networking system 1360 may create an edge (e.g., an “eat” edge) between a user node 1402 corresponding to the user and a concept node 1404 corresponding to the third-party webpage or resource and store edge 1406 in one or more data stores.

In particular embodiments, a pair of nodes in social graph 1400 may be connected to each other by one or more edges 1406. An edge 1406 connecting a pair of nodes may represent a relationship between the pair of nodes. In particular embodiments, an edge 1406 may include or represent one or more data objects or attributes corresponding to the relationship between a pair of nodes. As an example and not by way of limitation, a first user may indicate that a second user is a “friend” of the first user. In response to this indication, social-networking system 1360 may send a “friend request” to the second user. If the second user confirms the “friend request,” social-networking system 1360 may create an edge 1406 connecting the first user's user node 1402 to the second user's user node 1402 in social graph 1400 and store edge 1406 as social-graph information in one or more of data stores. In the example of FIG. 14, social graph 1400 includes an edge 1406 indicating a friend relation between user nodes 1402 of user “A” and user “B” and an edge indicating a friend relation between user nodes 1402 of user “C” and user “B.” Although this disclosure describes or illustrates particular edges 1406 with particular attributes connecting particular user nodes 1402, this disclosure contemplates any suitable edges 1406 with any suitable attributes connecting user nodes 1402. As an example and not by way of limitation, an edge 1406 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1400 by one or more edges 1406.

In particular embodiments, an edge 1406 between a user node 1402 and a concept node 1404 may represent a particular action or activity performed by a user associated with user node 1402 toward a concept associated with a concept node 1404. As an example and not by way of limitation, as illustrated in FIG. 14, a user may “like,” “attended,” “played,” “listened,” “cooked,” “worked at,” or “watched” a concept, each of which may correspond to a edge type or subtype. A concept-profile page corresponding to a concept node 1404 may include, for example, a selectable “check in” icon (such as, for example, a clickable “check in” icon) or a selectable “add to favorites” icon. Similarly, after a user clicks these icons, social-networking system 1360 may create a “favorite” edge or a “check in” edge in response to a user's action corresponding to a respective action. As another example and not by way of limitation, a user (user “C”) may listen to a particular song (“Song Name”) using a particular application (an online music application). In this case, social-networking system 1360 may create a “listened” edge 1406 and a “used” edge (as illustrated in FIG. 2) between user nodes 1402 corresponding to the user and concept nodes 1404 corresponding to the song and application to indicate that the user listened to the song and used the application. Moreover, social-networking system 1360 may create a “played” edge 1406 (as illustrated in FIG. 2) between concept nodes 1404 corresponding to the song and the application to indicate that the particular song was played by the particular application. In this case, “played” edge 1406 corresponds to an action performed by an external application (“online music app”) on an external audio file (the song “Song Name”). Although this disclosure describes particular edges 1406 with particular attributes connecting user nodes 1402 and concept nodes 1404, this disclosure contemplates any suitable edges 1406 with any suitable attributes connecting user nodes 1402 and concept nodes 1404. Moreover, although this disclosure describes edges between a user node 1402 and a concept node 1404 representing a single relationship, this disclosure contemplates edges between a user node 1402 and a concept node 1404 representing one or more relationships. As an example and not by way of limitation, an edge 1406 may represent both that a user likes and has used at a particular concept. Alternatively, another edge 1406 may represent each type of relationship (or multiples of a single relationship) between a user node 1402 and a concept node 1404 (as illustrated in FIG. 2 between user node 1402 for user “E” and concept node 1404 for “online music app”).

In particular embodiments, social-networking system 1360 may create an edge 1406 between a user node 1402 and a concept node 1404 in social graph 1400. As an example and not by way of limitation, a user viewing a concept-profile page (such as, for example, by using a web browser or a special-purpose application hosted by the user's client system 130) may indicate that he or she likes the concept represented by the concept node 1404 by clicking or selecting a “Like” icon, which may cause the user's client system 130 to send to social-networking system 1360 a message indicating the user's liking of the concept associated with the concept-profile page. In response to the message, social-networking system 1360 may create an edge 1406 between user node 1402 associated with the user and concept node 1404, as illustrated by “like” edge 1406 between the user and concept node 1404. In particular embodiments, social-networking system 1360 may store an edge 1406 in one or more data stores. In particular embodiments, an edge 1406 may be automatically formed by social-networking system 1360 in response to a particular user action. As an example and not by way of limitation, if a first user uploads a picture, watches a movie, or listens to a song, an edge 1406 may be formed between user node 1402 corresponding to the first user and concept nodes 1404 corresponding to those concepts. Although this disclosure describes forming particular edges 1406 in particular manners, this disclosure contemplates forming any suitable edges 1406 in any suitable manner.

In particular embodiments, social-networking system 1360 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 1370 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 1360 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 1360 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 1360 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 1360 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 1360 may calculate a coefficient based on a user's actions. Social-networking system 1360 may monitor such actions on the online social network, on a third-party system 1370, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 1360 may calculate a coefficient based on the user's actions with particular types of content. The content may be associated with the online social network, a third-party system 1370, or another suitable system. The content may include users, profile pages, posts, news stories, headlines, instant messages, chat room conversations, emails, advertisements, pictures, video, music, other suitable objects, or any combination thereof. Social-networking system 1360 may analyze a user's actions to determine whether one or more of the actions indicate an affinity for subject matter, content, other users, and so forth. As an example and not by way of limitation, if a user frequently posts content related to “coffee” or variants thereof, social-networking system 1360 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 1360 may calculate a coefficient based on the type of relationship between particular objects. Referencing the social graph 1400, social-networking system 1360 may analyze the number and/or type of edges 1406 connecting particular user nodes 1402 and concept nodes 1404 when calculating a coefficient. As an example and not by way of limitation, user nodes 1402 that are connected by a spouse-type edge (representing that the two users are married) may be assigned a higher coefficient than a user nodes 1402 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 1360 may determine that the user has a higher coefficient with respect to the first photo than the second photo because having a tagged-in-type relationship with content may be assigned a higher weight and/or rating than having a like-type relationship with content. In particular embodiments, social-networking system 1360 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 1360 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 1400. As an example and not by way of limitation, social-graph entities that are closer in the social graph 1400 (i.e., fewer degrees of separation) may have a higher coefficient than entities that are further apart in the social graph 1400.

In particular embodiments, social-networking system 1360 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 1360 may determine that the user has a higher coefficient for the airport than the gas station based on the proximity of the airport to the user.

In particular embodiments, social-networking system 1360 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 1360 may provide information that is relevant to user's interests and current circumstances, increasing the likelihood that they will find such information of interest. In particular embodiments, social-networking system 1360 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 1360 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 1360 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 1370 (e.g., via an API or other communication channel), or from another suitable system. In response to the request, social-networking system 1360 may calculate the coefficient (or access the coefficient information if it has previously been calculated and stored). In particular embodiments, social-networking system 1360 may measure an affinity with respect to a particular process. Different processes (both internal and external to the online social network) may request a coefficient for a particular object or set of objects. Social-networking system 1360 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 1360, a client system 130, a third-party system 1370, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node 1404 corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 1360 or shared with other systems (e.g., a third-party system 1370). Although this disclosure describes using particular privacy settings in a particular manner, this disclosure contemplates using any suitable privacy settings in any suitable manner.

In particular embodiments, privacy settings may be based on one or more nodes or edges of a social graph 1400. A privacy setting may be specified for one or more edges 1406 or edge-types of the social graph 1400, or with respect to one or more nodes 1402, 1404 or node-types of the social graph 1400. The privacy settings applied to a particular edge 1406 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 1360. The object may be associated with a concept node 1404 connected to a user node 1402 of the first user by an edge 1406. The first user may specify privacy settings that apply to a particular edge 1406 connecting to the concept node 1404 of the object, or may specify privacy settings that apply to all edges 1406 connecting to the concept node 1404. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 1360 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 1360 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 1670, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 1362 may be authorization/privacy servers for enforcing privacy settings. In response to a request from a user (or other entity) for a particular object stored in a data store 1364, the social-networking system 1360 may send a request to the data store 1364 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 1664 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 1660, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 1360 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 1360 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 1360 may access such information in order to provide a particular function or service to the first user, without the social-networking system 1360 having access to that information for any other purposes. Before accessing, storing, or using such objects or information, the social-networking system 1360 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 1360.

In particular embodiments, a user may specify whether particular types of objects or information associated with the first user may be accessed, stored, or used by the social-networking system 1360. As an example and not by way of limitation, the first user may specify that images sent by the first user through the social-networking system 1360 may not be stored by the social-networking system 1360. As another example and not by way of limitation, a first user may specify that messages sent from the first user to a particular second user may not be stored by the social-networking system 1360. As yet another example and not by way of limitation, a first user may specify that all objects sent via a particular application may be saved by the social-networking system 1360.

In particular embodiments, privacy settings may allow a first user to specify whether particular objects or information associated with the first user may be accessed from particular client systems 130 or third-party systems 1370. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 1360 may provide default privacy settings with respect to each device, system, or application, and/or the first user may be prompted to specify a particular privacy setting for each context. As an example and not by way of limitation, the first user may utilize a location-services feature of the social-networking system 1360 to provide recommendations for restaurants or other places in proximity to the user. The first user's default privacy settings may specify that the social-networking system 1360 may use location information provided from a client device 130 of the first user to provide the location-based services, but that the social-networking system 1360 may not store the location information of the first user or provide it to any third-party system 1370. The first user may then update the privacy settings to allow location information to be used by a third-party image-sharing application in order to geo-tag photos.

User-Initiated Changes to Privacy Settings

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system 1360 may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system 1360 may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system 1360 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system 1360 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system 1360 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system 1360 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system 1360 may send a reminder to the user to confirm his or her privacy settings every six months or after every ten photo posts. In particular embodiments, privacy settings may also allow users to control access to the objects or information on a per-request basis. As an example and not by way of limitation, the social-networking system 1360 may notify the user whenever a third-party system 1370 attempts to access information associated with the user, and require the user to provide verification that access should be allowed before proceeding.

### Systems and Methods

FIG. 15 illustrates an example computer system 1500. In particular embodiments, one or more computer systems 1500 perform one or more steps of one or more methods described or illustrated herein. In particular embodiments, one or more computer systems 1500 provide functionality described or illustrated herein. In particular embodiments, software running on one or more computer systems 1500 performs one or more steps of one or more methods described or illustrated herein or provides functionality described or illustrated herein. Particular embodiments include one or more portions of one or more computer systems 1500. Herein, reference to a computer system may encompass a computing device, and vice versa, where appropriate. Moreover, reference to a computer system may encompass one or more computer systems, where appropriate.

This disclosure contemplates any suitable number of computer systems 1500. This disclosure contemplates computer system 1500 taking any suitable physical form. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example and not by way of limitation, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

In particular embodiments, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1502 includes hardware for executing instructions, such as those making up a computer program. As an example and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular embodiments, processor 1502 may include one or more internal caches for data, instructions, or addresses. This disclosure contemplates processor 1502 including any suitable number of any suitable internal caches, where appropriate. As an example and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up read or write operations by processor 1502. The TLBs may speed up virtual-address translation for processor 1502. In particular embodiments, processor 1502 may include one or more internal registers for data, instructions, or addresses. This disclosure contemplates processor 1502 including any suitable number of any suitable internal registers, where appropriate. Where appropriate, processor 1502 may include one or more arithmetic logic units (ALUs); be a multi-core processor; or include one or more processors 1502. Although this disclosure describes and illustrates a particular processor, this disclosure contemplates any suitable processor.

In particular embodiments, memory 1504 includes main memory for storing instructions for processor 1502 to execute or data for processor 1502 to operate on. As an example and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular embodiments, processor 1502 executes only instructions in one or more internal registers or internal caches or in memory 1504 (as opposed to storage 1506 or elsewhere) and operates only on data in one or more internal registers or internal caches or in memory 1504 (as opposed to storage 1506 or elsewhere). One or more memory buses (which may each include an address bus and a data bus) may couple processor 1502 to memory 1504. Bus 1512 may include one or more memory buses, as described below. In particular embodiments, one or more memory management units (MMUs) reside between processor 1502 and memory 1504 and facilitate accesses to memory 1504 requested by processor 1502. In particular embodiments, memory 1504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1504 may include one or more memories 1504, where appropriate. Although this disclosure describes and illustrates particular memory, this disclosure contemplates any suitable memory.

In particular embodiments, storage 1506 includes mass storage for data or instructions. As an example and not by way of limitation, storage 1506 may include a hard disk drive (HDD), a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular embodiments, storage 1506 is non-volatile, solid-state memory. In particular embodiments, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages 1506. Although this disclosure describes and illustrates particular storage, this disclosure contemplates any suitable storage.

In particular embodiments, I/O interface 1508 includes hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1508 for them. Where appropriate, I/O interface 1508 may include one or more device or software drivers enabling processor 1502 to drive one or more of these I/O devices. I/O interface 1508 may include one or more I/O interfaces 1508, where appropriate. Although this disclosure describes and illustrates a particular I/O interface, this disclosure contemplates any suitable I/O interface.

In particular embodiments, communication interface 1510 includes hardware, software, or both providing one or more interfaces for communication (such as, for example, packet-based communication) between computer system 1500 and one or more other computer systems 1500 or one or more networks. As an example and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces 1510, where appropriate. Although this disclosure describes and illustrates a particular communication interface, this disclosure contemplates any suitable communication interface.

In particular embodiments, bus 1512 includes hardware, software, or both coupling components of computer system 1500 to each other. As an example and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1512 may include one or more buses 1512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
determining, based on frames captured by a camera, a plurality of participants are located in an environment;
locating, within a first frame, a first body region of a first participant of the plurality of participants;
detecting, at a first time, appearance information of the first body region of the first participant;
calculating, using one or more machine-learning models, a confidence score corresponding to a match between the appearance information of the first participant at the first time and one or more profiles of pre-registered participants;
updating, using the one or more machine-learning models, the confidence score based on one or more additional appearance information detected within additional frames;
determining whether the updated confidence score is above a predetermined threshold; and
in response to determining the updated confidence score is above the predetermined threshold, authenticating the first participant.

2. The method of claim 1, further comprising:
determining the updated confidence score is not above a predetermined threshold; and
capturing additional frames of the first body region of the first participant at a second time.

3. The method of claim 2, further comprising:
detecting, at the second time, appearance information of the first body region of the first participant;
calculating, using the one or more machine-learning models, a second confidence score corresponding to a match between the appearance information of the first participant at the second time and one or more profiles of pre-registered participants;
updating the second confidence score based on one or more additional appearance information detected within additional frames;
determining whether the updated second confidence score is above the predetermined threshold; and
in response to determining the updated second confidence score is above the predetermined threshold, authenticating the first participant.

4. The method of claim 1, further comprising:
executing one or more tasks associated with the authentication of the first participant, the one or more tasks based on a pre-registered profile corresponding to the first participant.

5. The method of claim 4, further comprising:
determining one or more privacy restrictions corresponding to the one or more tasks, wherein the privacy restrictions are determined based on the pre-registered profile corresponding to the first participant.

6. The method of claim 1, further comprising:
locating a second body region of the first participant;
generating a color histogram of the second body region of the first participant; and
storing the color histogram of the second body region of the first participant in a pre-registered profile corresponding to the first participant.

7. The method of claim 1, further comprising:
locating, within the first frame, a first body region of a second participant of the plurality of participants;
detecting at a first time, appearance information of the first body region of the second participant;
calculating, using one or more machine-learning models, a confidence score corresponding to a match between the appearance information of the second participant at the first time and one or more profiles of pre-registered participants;
updating, using the one or more machine-learning models, the confidence score based on one or more additional appearance information detected within additional frames;
determining whether the updated confidence score is above the predetermined threshold;
in response to determining the updated confidence score is above the predetermined threshold, authenticating the second participant; and
executing one or more tasks associated with the first participant, the one or more tasks based on the pre-registered profiles corresponding to the first participant and second participant, respectively.

8. An electronic device comprising:
one or more displays;
one or more non-transitory computer-readable storage media including instructions; and
one or more processors coupled to the storage media, the one or more processors configured to execute the instructions to:
determine, based on frames captured by a camera, a plurality of participants are located in an environment;
locate, within a first frame, a first body region of a first participant of the plurality of participants;
detect, at a first time, appearance information of the first body region of the first participant;
calculate using one or more machine-learning models, a confidence score corresponding to a match between the appearance information of the first participant at the first time and one or more profiles of pre-registered participants;
update, using the one or more machine-learning models, the confidence score based on one or more additional appearance information detected within additional frames;
determine whether the updated confidence score is above a predetermined threshold; and
in response to determining the updated confidence score is above the predetermined threshold, authenticate the first participant.

9. The electronic device of claim 8, wherein the processors are further configured to execute the instructions to:
determine the updated confidence score is not above a predetermined threshold; and
capture additional frames of the first body region of the first participant at a second time.

10. The electronic device of claim 9, wherein the processors are further configured to execute the instructions to:
detect, at the second time, appearance information of the first body region of the first participant;
calculate, using the one or more machine-learning models, a second confidence score corresponding to a match between the appearance information of the first participant at the second time and one or more profiles of pre-registered participants;
update the second confidence score based on one or more additional appearance information detected within additional frames;
determine whether the updated second confidence score is above the predetermined threshold; and
in response to determining the updated second confidence score is above the predetermined threshold, authenticate the first participant.

11. The electronic device of claim 8, wherein the processors are further configured to execute the instructions to:
execute one or more tasks associated with the authentication of the first participant, the one or more tasks based on a pre-registered profile corresponding to the first participant.

12. The electronic device of claim 11, wherein the processors are further configured to execute the instructions to:
determine one or more privacy restrictions corresponding to the one or more tasks, wherein the privacy restrictions are determined based on the pre-registered profile corresponding to the first participant.

13. The electronic device of claim 8, wherein the processors are further configured to execute the instructions to:
locate a second body region of the first participant;
generate a color histogram of the second body region of the first participant; and
store the color histogram of the second body region of the first participant in a pre-registered profile corresponding to the first participant.

14. The electronic device of claim 8, wherein the processors are further configured to execute the instructions to:
locate, within a first frame, a first body region of a second participant of the plurality of participants;
detect at a first time, appearance information of the first body region of the second participant;
calculate, using one or more machine-learning models, a confidence score corresponding to a match between the appearance information of the second participant at the first time and one or more profiles of pre-registered participants;
update, using the one or more machine-learning models, the confidence score based on one or more additional appearance information detected within additional frames;
determine whether the updated confidence score is above the predetermined threshold;
in response to determining the updated confidence score is above the predetermined threshold, authenticate the second participant; and
execute one or more tasks associated with the first participant, the one or more tasks based on the pre-registered profiles corresponding to the first participant and second participant, respectively.

15. A computer-readable non-transitory storage media comprising instructions executable by a processor to:
determine, based on frames captured by a camera, a plurality of participants are located in an environment;
locate, within a first frame, a first body region of a first participant of the plurality of participants;
detect, at a first time, appearance information of the first body region of the first participant;
calculate using one or more machine-learning models, a confidence score corresponding to a match between the appearance information of the first participant at the first time and one or more profiles of pre-registered participants;
update, using the one or more machine-learning models, the confidence score based on one or more additional appearance information detected within additional frames;
determine whether the updated confidence score is above a predetermined threshold; and
in response to determining the updated confidence score is above the predetermined threshold, authenticate the first participant.

16. The media of claim 15, wherein the instructions are further executable by the processor to:
determine the updated confidence score is not above a predetermined threshold; and
capture additional frames of the first body region of the first participant at a second time.

17. The media of claim 16, wherein the instructions are further executable by the processor to:
detect, at the second time, appearance information of the first body region of the first participant;
calculate, using the one or more machine-learning models, a second confidence score corresponding to a match between the appearance information of the first participant at the second time and one or more profiles of pre-registered participants;
update the second confidence score based on one or more additional appearance information detected within additional frames;
determine whether the updated second confidence score is above the predetermined threshold; and
in response to determining the updated second confidence score is above the predetermined threshold, authenticate the first participant.

18. The media of claim 15, wherein the instructions are further executable by the processor to:
execute one or more tasks associated with the authentication of the first participant, the one or more tasks based on a pre-registered profile corresponding to the first participant.

19. The media of claim 18, wherein the instructions are further executable by the processor to:
determine one or more privacy restrictions corresponding to the one or more tasks, wherein the privacy restrictions are determined based on the pre-registered profile corresponding to the first participant.

20. The media of claim 15, wherein the instructions are further executable by the processor to:
locate a second body region of the first participant;
generate a color histogram of the second body region of the first participant; and
store the color histogram of the second body region of the first participant in a pre-registered profile corresponding to the first participant.
